(19) United States
(12) Patent Application Publication
(10) Pub. No.: US 2007/0172658 A1
(43) Pub. Date: Jul. 26, 2007

(54) Method for enhancing the water repellency of inorganic binder compositions, the compositions capable of being obtained by this method and the uses of these compositions

(76) Inventors: Martial Deruelle, Mornant (FR); Daniel Joubert, Vineuil Saint Firmin (FR); Jean-Christophe Castaing, Paris (FR)

Correspondence Address: Jean-Louis Seugnet;Rhodia Inc, 259 Prospect Plains Road, CN 7500, Cranbury, NJ, 08512, US

(21) Appl. No.: 10/549,218

(22) PCT Filed: Mar. 5, 2004
(86) PCT No.: PCT/FR04/00528

§ 371 Date: Aug. 21, 2006

(30) Foreign Application Priority Data
Mar. 10, 2003 (FR) 03/02921

(51) Int. Cl. B32B 13/00; C08L 83/04

(52) U.S. Cl. 428/405; 525/100; 106/606

(57) ABSTRACT

The invention relates to a method for increasing the waterproofing of a mineral binder compound consisting in adding the sufficient quantity of at least one type of polyalkylalkylsiloxane containing at least one hydrocarbon graft which has 6-18 carbon atoms to said compound. Compounds which can be produced with the inventive method and the use thereof for construction are also disclosed.

The present invention relates to a method for enhancing the water repellency of inorganic binder compositions, to the compositions capable of being obtained by this method and to the uses of these compositions in the field of building.

Ever since mankind began constructing artificial dwellings, one problem has been the penetration of moisture into these dwellings. Exposure to events due to the weather, such as rain and snow, can be reduced to a minimum by suitable building, for example roofs with a satisfactory overhang. However, this does not make it possible to control the absorption of water by the building materials due to their capillary action. This can result in leaching of the salts, causing irreversible damage to the cement and thus to the entire composite mortar. To prevent this effect requires that the building structures either be subsequently covered with tar emulsions, asphalt emulsions, wax emulsions or paraffin emulsions, or be impregnated.

Provision has been made for the addition of polysiloxanes in the document EP 741 759 from Wacker.

The need exists to find a water repellent which is more effective than the water repellents known to date.

A subject matter of the present invention is thus a method for enhancing the water repellency of an inorganic binder composition, characterized in that a sufficient amount of at least one polyalkylalkylsiloxane comprising at least one hydrocarbon graft having between 6 and 18 carbon atoms is added to said composition.

The inorganic binders can be chosen from hydraulic binders or nonhydraulic binders.

A hydraulic binder within the meaning of the present invention is a binder which sets on contact with water and which, once cured, is no longer sensitive to water.

Mention may be made, as examples of hydraulic binders, of cements, which can be of Portland, high-alumina or blast-furnace type.

A nonhydraulic binder within the meaning of the present invention is a binder which sets on contact with water and which, once cured, remains sensitive to water.

Mention may be made, as examples of nonhydraulic binders, of plasters.

Other compounds often added as inorganic additives to cement also exhibit hydraulic properties, such as fly ash, calcined shales and natural or synthetic pozzolans. These inorganic additives, referred to as “pozzolanic compounds”, react with lime and form calcium silicate hydrates.

Preferably, the inorganic binders are inorganic hydraulic binders.

Inorganic hydraulic binders are generally based on cement. They can be in the form of grouts, mortars or concretes. They are used, for example, in the following applications: tiling bonding cements, sealing mortars, single surface dressings, external thermal insulation systems, smoothing and finishing coatings, adhesives and coatings for insulating complexes, repair mortars, leaktight coatings and grouts for the cementation of oil wells.

The polyalkylalkylsiloxane of the invention comprises at least one hydrocarbon graft having between 6 and 18 carbon atoms.

The length of the hydrocarbon chain of the graft used is between 6 and 18 carbon atoms. Preferably, the length of the hydrocarbon chain is between 8 and 12 carbon atoms. More preferably still, the length of the hydrocarbon chain is 12 carbon atoms.

The hydrocarbon chain of the graft can be saturated or unsaturated and branched or linear. It can also comprise halogens, such as fluorine or chlorine, and hydroxyl groups, ether groups, thioether groups, ester groups, amide groups, carboxyl groups, sulfonic acid groups, carboxylic anhydride groups and/or carbonyl groups.

The polyalkylalkylsiloxane of the invention comprising at least one hydrocarbon graft having between 6 and 18 carbon atoms is chosen from organopolysiloxanes which are liquid at ambient temperature.

The organopolysiloxanes are polysiloxane polymers comprising a graft which is an organic radical.

The polysiloxane polymers can be linear, cyclic or branched.

The organic radicals are monovalent hydrocarbon radicals having from 1 to 18 carbon atoms.

The polymer can additionally comprise one or more hydrogen atoms bonded to silicon and/or one or more hydroxyl and/or alkoxyl groups.

The linear polymers are composed of diorganosiloxy sequences of formula RR′SiO in which the symbols R and R′, which are identical or different, represent hydrocarbon radicals, in which one at least of R or R′ has a hydrocarbon chain having from 6 to 18 carbon atoms.

Hydrocarbon radicals represented by the symbols R or R′ encompass:
alkyl radicals having from 1 to 18 carbon atoms, such as the methyl, ethyl, propyl, isopropyl, butyl, pentyl, hexyl, 2-ethylhexyl, octyl, decyl, dodecyl or stearyl radicals,
cycloalkyl radicals having up to 10 carbon atoms, such as the cyclopentyl or cyclohexyl radicals,
alkenyl radicals having from 2 to 4 carbon atoms, such as the vinyl, allyl or buten-2-yl radicals,
mononuclear allyl radicals having from 6 to 10 carbon atoms, such as the phenyl, tolyl or xylyl radicals.

The octyl and dodecyl radicals are the preferred radicals.

Representative examples of organopolysiloxane polymers comprise:
α,ω-bis(triorganosiloxy)diorganopolysiloxane polymers, the organic radicals of which bonded to the silicon atoms are chosen from the methyl, vinyl or phenyl radicals; for example, α,ω-bis(trimethylsiloxy)methylalkylpolysiloxane oils of formula (I):
   M−[D(R)]ₓ−M (I)
   in which,

x is a whole or fractional number between 5 and 500, preferably between 20 and 80, more preferably still between 30 and 60 and more advantageously still approximately 50,
M represents (CH₃)₃Si—O—,
D(R) represents —Si(CH₃)(alkyl)-O—.

The alkyl radical can be cyclic, linear or branched and comprises 6 to 18 carbon atoms. Preferably, the alkyl radical comprises between 8 and 12 carbon atoms. More preferably still, the alkyl radical is octyl or dodecyl;
α,ω-di(hydroxy)diorganopolysiloxane polymers blocked at each end of their chain by a hydroxyl group, with a viscosity preferably of 5 mPa.s to 5000 mPa.s at 25° C.; for example, α,ω-di(hydroxy)methyl-phenylpolysiloxane oils;
branched organosiloxane polymers (silicone resins) which are liquid at ambient temperature, comprising one or more units chosen from those of formulae RR′SiO (D unit), RSiO_{1.5} (T unit) and SiO₂ (Q unit) in which the R and R′ radicals are alkyl radicals having from 1 to 18 carbon atoms with one at least of the R or R′ radicals comprising between 6 and 18 carbon atoms;
organohydropolysiloxane polymers having at least one hydrocarbon graft having between 6 and 18 carbon atoms.

The linear, cyclic or branched liquid organopolysiloxanes can, of course, be used alone or as a mixture with one another.

The polyalkylalkylsiloxane comprising at least one hydrocarbon graft having from 6 and 18 carbon atoms can be incorporated in the form of a solid powder, obtained by processes for the impregnation of silicones on a porous support or processes for the preparation of water-redispersible pulverulent silicone compositions, also known as dried silicone emulsions, such as disclosed, for example, in the documents FR 95 12586, FR 95 12587, WO 97/15385, WO 99/38611, WO 99/38911 or WO 00/26280, or in the form of an emulsion in a sufficient amount in the building composition.

The polyalkylalkylsiloxane comprising at least one hydrocarbon graft having between 6 and 18 carbon atoms can also be premixed in a sufficient amount with a latex composition.

This second embodiment is preferred.

This premix of the polyalkylalkylsiloxane comprising at least one hydrocarbon graft having between 6 and 18 carbon atoms and of the latex can be prepared as an emulsion by mixing the polyalkylalkylsiloxane, in the form of an emulsion, with the aqueous dispersion of polymer as an emulsion (latex) during the polymerization or in postpolymerization. This premix can then be dried by spray drying in order to obtain a redispersible powder.

It is also possible to add the polyalkylalkylsiloxane comprising at least one hydrocarbon graft having between 6 and 18 carbon atoms in the form of a dry emulsion, that is to say of a powder, in the tower in which the latex is atomized, that is to say during the drying of the latex.

The premix can also be prepared by powder-powder mixing of a dried emulsion formed of polyalkylalkylsiloxane comprising at least one hydrocarbon graft having between 6 to 18 carbon atoms, for example obtained by one of the processes described above, and of a redispersible latex powder.

Methods for the preparation of pulverulent compositions formed of polymers which are insoluble and which are dispersible in an aqueous medium, also known as redispersible latex powders, have already been disclosed by the Applicant Company, for example in the following documents: WO 96/17891, WO 97/15617, WO 97/15616 and WO 97/25371.

Preference is given, among all these possible forms of premixes, to the case where a solid powder formed of the polyalkylalkylsiloxane comprising at least one hydrocarbon graft having between 6 and 18 carbon atoms is mixed in a sufficient amount with a redispersible latex powder composition.

This is because this makes it possible to improve the redispersing of the mixture and to limit the phenomena of caking during storage.

The emulsifiers used to emulsify the polyalkylalkylsiloxanes of the invention can be anionic, cationic or nonionic emulsifiers or their mixtures.

Mention may be made, among nonionic emulsifiers, of ethoxylated fatty alcohols.

Mention may be made, among anionic emulsifiers, of fatty acid salts. Mention may in particular be made of sodium laurate or potassium laurate.

Use may also be made of poly(vinyl alcohol) for emulsifying the polyalkylalkylsiloxanes of the invention.

The term “sufficient amount of polyalkylalkylsiloxane” is understood to mean, within the meaning of the invention, an amount of polyalkylalkylsiloxane sufficient to contribute good water repellency to the building composition.

When the polyalkylalkylsiloxane comprising at least one hydrocarbon graft having between 6 and 18 carbon atoms is added directly to the building composition, the sufficient amount is between 0.001% and 3% by dry weight of the polyalkylalkylsiloxane comprising at least one hydrocarbon graft having between 6 and 18 carbon atoms, with respect to the total weight of the building composition.

Preferably, this amount is between 0.01% and 0.5% by dry weight of the polyalkylalkylsiloxane comprising at least one hydrocarbon graft having between 6 and 18 carbon atoms, with respect to the total weight of the building composition.

More preferably still, this amount is between 0.03% and 0.2% by dry weight of the polyalkylalkylsiloxane comprising at least one hydrocarbon graft having between 6 and 18 carbon atoms, with respect to the total weight of the building composition.

This sufficient amount is low, which exhibits the advantage of avoiding damage to the adhesive properties of the additivated inorganic binders.

When the polyalkylalkylsiloxane comprising at least one hydrocarbon graft having between 6 and 18 carbon atoms is premixed in the form of a solid powder with a redispersible latex powder composition, the sufficient amount is between 0.1% and 20% by weight of polyalkylalkylsiloxane comprising at least one hydrocarbon graft having between 6 and 18 carbon atoms, with respect to the weight of the dry latex.

Preferably, this amount is between 1% and 10% by weight of polyalkylalkylsiloxane comprising at least one hydrocarbon graft having between 6 and 18 carbon atoms, with respect to the weight of the dry latex.

More preferably still, this amount is between 3% and 7% by weight of polyalkylalkylsiloxane comprising at least one hydrocarbon graft having between 6 and 18 carbon atoms, with respect to the weight of the dry latex.

The redispersible latex powder used can be of highly varied nature.

Preference is particularly given to a latex composition in the form of a redispersible powder comprising:
at least one water-insoluble polymer,
from 0 to 35% by weight, with respect to the total weight of the polymer, of at least one protective colloid,
from 0 to 30% by weight, with respect to the total weight of the polymer, of anticaking agents, and
from 0.1 to 20% by weight, with respect to the total weight of the polymer, of the polyalkylalkylsiloxane comprising at least one hydrocarbon graft having between 6 and 18 carbon atoms.

Suitable water-insoluble polymers are homo- or copolymers which are in the form of an aqueous dispersion or which can be converted to an aqueous dispersion and which can subsequently be put into the powder form by drying by atomization.

The mean particle size of the powder is preferably from 1 to 1000 μm, more preferably from 10 to 700 μm and particularly from 50 to 500 μm.

The preferred water-insoluble polymers are obtained by polymerization of monomers chosen from:
vinyl esters and more particularly vinyl acetate;
alkyl acrylates and methacrylates, the alkyl group of which comprises from 1 to 10 carbon atoms, for example methyl, ethyl, n-butyl or 2-ethylhexyl acrylates and methacrylates,
vinylaromatic monomers, in particular styrene.

These monomers can be copolymerized with one another or with other monomers possessing ethylenic unsaturation to form homopolymers, copolymers or terpolymers.

Mention may be made, as nonlimiting examples of monomers which can be copolymerized with vinyl acetate and/or acrylic esters and/or styrene, of ethylene and olefins, such as isobutene; vinyl esters of saturated, branched or unbranched, monocarboxylic acids having from 1 to 12 carbon atoms, such as vinyl propionate, vinyl “Versatate” (registered trade mark for the esters of branched C₉-C₁₁ acids), vinyl pivalate or vinyl laurate; esters of unsaturated mono- or dicarboxylic acids having 3 to 6 carbon atoms with alkanols having 1 to 10 carbon atoms, such as methyl, ethyl, butyl or ethylhexyl maleates or fumarates; vinylaromatic monomers, such as methylstyrenes or vinyltoluenes; vinyl halides, such as vinyl chloride or vinylidene chloride; diolefins, particularly butadiene; (meth)allyl esters of (meth)acrylic acid; (meth)allyl esters of the mono- and diesters of maleic, fumaric and itaconic acids; and alkene derivatives of amides of acrylic and methacrylic acids, such as N-methallylmaleimide.

It is possible in particular to choose at least 2 copolymerizable monomers of different natures in order to obtain a terpolymer.

Mention may be made, as example, of a terpolymer of acetate/versatate/dibutyl maleate type.

It is also possible to add, to the monomers which can be copolymerized with vinyl acetate and/or acrylic esters and/or styrene, at least one other monomer chosen from the following list: acrylamide, carboxylic or dicarboxylic acids possessing ethylenic unsaturation, preferably acrylic acid or methacrylic acid, sulfonic acids possessing ethylenic unsaturation and salts of the latter, preferably vinylsulfonic acid or 2-acrylamido-2-methylpropanesulfonic acid (AMPS), or sodium methallylsulfonate.

These monomers are added in an amount of between 0.05 and 10.0% by weight, with respect to the total weight of the monomers. These monomers are added during the polymerization; they provide the colloidal stability of the latex.

Generally, the polymerization of the monomers is carried out under emulsion conditions in the presence of an emulsifier and of a polymerization initiator.

The monomers employed can be introduced as a mixture or separately and simultaneously into the reaction medium, either before the beginning of the polymerization, all at once, or during the polymerization, in successive fractions or continuously.

The emulsifiers which can be used are anionic, cationic or nonionic emulsifiers.

They are generally employed in a proportion of 0.01 to 5% by weight, with respect to the total weight of the monomers.

Use is generally made, as emulsifying agent, of conventional anionic agents represented in particular by alkali metal alkyl sulfates, alkylsulfonates, alkylaryl sulfates, alkylarylsulfonates, aryl sulfates, arylsulfonates, sulfosuccinates or alkyl phosphates, or salts of hydrogenated or nonhydrogenated abietic acid.

The emulsion polymerization initiator is represented more particularly by hydroperoxides, such as aqueous hydrogen peroxide solution, cumene hydroperoxide, diisopropylbenzene hydroperoxide, para-menthane hydroperoxide or tert-butyl hydroperoxide, and by persulfates, such as sodium persulfate, potassium persulfate or ammonium persulfate. It is employed in an amount of between 0.05 and 2% by weight, with respect to the total weight of the monomers. These initiators are optionally used in combination with a reducing agent, such as sodium bisulfite or formaldehydesulfoxylate, polyethyleneamines, sugars (dextrose, sucrose) or metal salts. The amount of reducing agent used varies from 0 to 3% by weight, with respect to the total weight of the monomers.

The reaction temperature, which depends on the initiator used, is generally between 0 and 100° C. and preferably between 30 and 90° C.

Use may be made of a transfer agent in proportions ranging from 0 to 3% by weight, with respect to the monomer(s), generally chosen from mercaptans, such as n-dodecyl mercaptan or tert-dodecyl mercaptan, cyclohexene or halogenated hydrocarbons, such as chloroform, bromoform or carbon tetrachloride. It makes it possible to regulate the length of the molecular chains. It is added to the reaction medium either before the polymerization or during polymerization.

In a particularly preferred embodiment, the latex composition in the form of a redispersible powder comprises 0 to 35% by weight, preferably 3 to 15% by weight, of protective colloid, with respect to the total weight of the water-insoluble polymer.

The suitable protective colloids are poly(vinyl alcohol)s and derivatives of the latter, for example vinyl alcohol/vinyl acetate copolymers, polyvinylpyrrolidones, polysaccharides, for example starches (amylose and amylopectin), cellulose, guar gum, tragacanthic acid, dextrin, alginates and their carboxymethyl, methyl, hydroxyethyl or hydroxypropyl derivatives, proteins, for example casein, soybean proteins or gelatins, synthetic polymers, for example poly(meth)acrylic acid, poly(meth)acrylamide, poly(vinylsulfonic acid)s and water-soluble copolymers of these, melamine-formaldehydesulfonates, naphthalene-formaldehydesulfonates, styrene/maleic acid copolymers and vinyl ether/maleic acid copolymers. Poly(vinyl alcohol) is particularly preferred as protective colloid for the polymerization. A protective colloid particularly used is a poly(vinyl alcohol) having a degree of polymerization of 200 to 3500 and having a degree of hydrolysis of 80 to 98 mol %.

The preferred anticaking agents are aluminum silicates, calcium or magnesium carbonates, or mixtures of these, silicas, aluminum hydrate, bentonite, talc, or mixtures of dolomite and of talc, or of calcite and of talc, kaolin, barium sulfate, titanium oxide, or calcium sulfoaluminate (satin white).

The particle size of the anticaking agents is preferably within the range from 0.001 to 0.5 mm.

The redispersible latex powder is preferably prepared by spray drying the aqueous polymer dispersion. This drying is carried out in conventional spray drying systems using atomization by means of single, double or multiple liquid nozzles or of a rotating disk. The discharge temperature chosen is generally within the range from 50 to 100° C., preferably from 60 to 90° C., depending on the system, the glass transition temperature of the latex and the degree of drying desired.

In order to enhance the storage stability and the flowability of the redispersible latex powder, it is preferable to introduce an anticaking agent into the spray column in conjunction with the aqueous polymer dispersion, which results in a preferable deposition of the anticaking agent over the particles of the dispersion.

Another subject matter of the present invention is an inorganic binder composition, the inorganic binders having improved water-repellent properties, which is capable of being obtained by one of the processes described above.

Another subject matter of the present invention is the use of this inorganic binder composition for enhancing the water repellency of building compositions.

The building compositions can in particular be coating compositions or inorganic building mixtures for producing inorganic components. The coating compositions are used in particular for inorganic substrates. The coating compositions can be aqueous or in the powder form. They are preferably in the powder form.

Examples of coating compositions are inorganic paints, lime paints, silicate paints, lime emulsion paints, silicate emulsion paints, priming coats, renders, for example mineral renders and silicate renders, high-filler coatings based on dispersions, fillers applied with a brush, reinforcing compositions, compounds coated with a trowel, and tiling adhesives, single surface dressings and also mortars, for example leaktight mortars, mortars for external thermal insulation systems, sealing mortars or plaster-based coatings.

For the requirements of the present invention, inorganic building mixtures are any one of the raw mixtures which can be used to produce inorganic components which are themselves used in civil engineering structures, and form part of civil engineering structures, in particular if they are exposed to bad weather or require another type of water repellency.

Examples of components are concrete roof slabs and prefabricated bricks, fiber-reinforced concrete slabs, and also other finished products or insulating components.

The inorganic building mixtures can be composed of concrete, lime, cement, quartz sand, clay minerals, such as calcium silicate, porous concrete, bricks or else building mixtures based on fibers in which the fibers are natural fibers or synthetic fibers. Suitable natural fibers are inorganic fibers, such as rock wool, quartz fibers or ceramic fibers, or plant fibers, such as cellulose. Examples of cellulose fibers are jute fibers, coconut fibers and hemp fibers, or fibers derived from paper, board or recycled paper. Examples of suitable synthetic fibers are glass fibers, polymer fibers and carbon fibers.

Apart from the inorganic constituents, inorganic building compositions can also comprise organic additives, for example cellulose ethers or plasticizers. Other organic additives which can be used in inorganic building compositions are known to a person skilled in the art.

The amounts of inorganic binder compositions with improved water-repelling properties generally used in building compositions are between 0.01 and 80% by weight.

The amounts of inorganic binder compositions with improved water-repelling properties preferably used in mortar compositions are between 30 and 50% by weight.

The invention is described in detail below using examples but is not limited to the latter. The proportions and percentages shown in the examples are by weight, unless otherwise indicated.

### EXAMPLES

### Example 1

Preparation 1 (liquid): An emulsion formed of acetate/versatate VeoVa10 (70/30) latex stabilized with polyvinyl alcohol with a solids content of 50% is mixed with various water-repelling additives (the list of which is given in table 1), also in the form of emulsions. Water is added so as to have a solids content of 5.3%.

Preparation 2 (powder): A mortar formulation (siliceous fillers) having the following composition is prepared:

| | | |
|---|---|---|
| Sand BE 01 | 62.450 | parts |
| Grey cement CEM I N CE CP2 NF | 35.000 | parts |
| Ternal RG | 1 | part |
| Boran lime | 0.5 | part |
| Culminal C8350 | 0.05 | part |

### Formulation 1

A mortar is prepared by adding Preparation 2 to 19 parts of Preparation 1. The proportions shown correspond to a mortar having 100 parts of dry matter and a degree of mixing of 18%.

The mortar is mixed and then introduced into a cylindrical mold (50 g of mortar). The combination is placed in a chamber, the relative humidity and CO₂ content of which are controlled by a supersaturated sodium bromide solution comprising 1M of sodium hydroxide. The samples are removed from the molds after conditioning for 1 day and then, after conditioning for 7 days, the curved face of the cylinders is coated with a paraffin mixture. The samples are subsequently brought into contact with deionized water via one of their flat faces. Water penetrates by capillary action into the cylinders, which are weighed after 30 minutes and 240 minutes. The weight of water which has penetrated is correlated with the surface area of the cylinders in contact with the water and divided by the square root of the contact time (unit=g/m²/\sqrt{h}).

This procedure makes it possible to compare the performances of different water repellents. For each of them, the study focuses on 3 levels (expressed as weight of dry water repellent with respect to the dry weight of the latex): 3%, 5% and 10%.

Additive 1

Emulsion formed of MDT silicone resin composed of 15% by weight of (Me)₃SiO_{1/2} (M) units, of 25% by weight of (Me)₂SiO_{2/2} (D) units and of 60% by weight of MeSiO_{3/2} (T) units.
Emulsifier: PVA; solids content: 54% by weight.
   Additive 2

Emulsion formed of polydimethylsiloxane (PDMS) oil having a viscosity of 350 mPa.s at 25° C.
Emulsifier: Nonionic SA; solids content: 60.4% by weight.
   Additive 3

Emulsion formed of MDT silicone resin composed of 15% by weight of (Me)₃SiO_{1/2} (M) units, of 25% by weight of (Me)₂SiO_{2/2} (D) units and of 60% by weight of MeSiO_{3/2} (T) units.
Emulsifier: Nonionic SA; solids content: 60.4% by weight.
   Additive according to the invention

Emulsion formed of silicone oil of formula (I) where the alkyl graft comprised in the symbol R comprises 12 carbon atoms and x=50+/−5.
Emulsifier: Nonionic SA; solids content: 56% by weight.

MDT 15% 25% 60%: denotes the percentage of silicon atoms bonded to 1 (M), 2 (D) or 3 (T) oxygen atoms.
PVA: Poly(vinyl alcohol)

Nonionic SA: Nonionic surfactant

TABLE 1

| | Composition of preparation 1 | | |
|---|---|---|---|
| | Latex | Additive | |
| Additive-level | (dry matter) | (dry matter) | Water |
| No additive | 5.26 parts | 0 part | 94.74 parts |
| Control | | | |
| Additive 1 - 3% | 5.10 parts | 0.16 part | 94.74 parts |
| Additive 1 - 5% | 5 parts | 0.26 part | 94.74 parts |
| Additive 1 - 10% | 4.74 parts | 0.53 part | 94.74 parts |
| Additive 2 - 3% | 5.10 parts | 0.16 part | 94.74 parts |
| Additive 2 - 5% | 5 parts | 0.26 part | 94.74 parts |
| Additive 2 - 10% | 4.74 parts | 0.53 part | 94.74 parts |
| Additive 3 - 3% | 5.10 parts | 0.16 part | 94.74 parts |
| Additive 3 - 5% | 5 parts | 0.26 part | 94.74 parts |
| Additive of the | 5.10 parts | 0.16 part | 94.74 parts |
| invention - 3% | | | |
| Additive of the | 5 parts | 0.26 part | 94.74 parts |
| invention - 5% | | | |
| Additive of the | 4.74 parts | 0.53 part | 94.74 parts |
| invention - 10% | | | |

The results obtained are presented in table 2. They reveal that the additive according to the invention substantially reduces the amount of water uptake, compared with the other silicone derivatives. The effectiveness of the additive according to the invention is noticeable, including when it is used at low levels (3% with respect to the latex).

TABLE 2

Water uptake (g/m²/\sqrt{h})

| | Measurement at | Measurement at |
|---|---|---|
| Nomenclature | 30 min | 240 min |
| Control | 469 | 435 |
| Additive 1 - 3% | 367 | 327 |
| Additive 1 - 5% | 544 | 413 |
| Additive 1 - 10% | 388 | 333 |
| Additive 2 - 3% | 393 | 387 |
| Additive 2 - 5% | 469 | 446 |
| Additive 2 - 10% | 525 | 469 |
| Additive 3 - 3% | 382 | 342 |
| Additive 3 - 5% | 621 | 481 |
| Additive of the | 254 | 242 |
| invention - 3% | | |
| Additive of the | 281 | 253 |
| invention - 5% | | |
| Additive of the | 291 | 256 |
| invention - 10% | | |

### Example 2

Mortar formulations according to the compositions described in example 1 are prepared. The mortars are mixed, then poured into standardized molds with dimensions of 4×4×16 cm and passed over a shock table. They are removed from the molds the day after and then placed for 28 days in a chamber conditioned at 23° C. and 55% relative humidity. They are subsequently coated with paraffin over 4 of their faces, forming a ring and including the 2 square faces. The samples are subsequently steeped via one of their free faces in deionized water. The amount of water taken up by capillary action (expressed in grams) is measured by weighing after 30 min and 240 min.

These tests make it possible to test the water-repellent nature of the additive according to the invention, according to another test protocol and with regard to mortars which have been subjected to a standardized cure of 28 days.

TABLE 3

| | Composition of preparation 1 | | |
|---|---|---|---|
| | Latex | Additive | |
| Additive nature | (dry matter) | (dry matter) | Water |
| No additive | 5.26 parts | 0 part | 94.74 parts |
| Control | | | |
| Additive of the | 5.10 parts | 0.16 part | 94.74 parts |
| invention - 3% | | | |

TABLE 4

Water uptake (g)

| | Measurement at | Measurement at |
|---|---|---|
| Additive nature | 30 min | 240 min |
| Control (no additive) | 2.7 | 6 |
| Additive of the | 2.2 | 4.4 |
| invention - 3% | | |

The comparison between the additive-free control and the mortar comprising an emulsion formed of a silicone oil functionalized with C₁₂, referred to here as additive of the invention, confirms that the additive according to the invention is an effective water repellent for very low levels of use (3% of additive with respect to the latex, the combination representing 1% of the dry weight of the mortar formulation).

1-27. (canceled)

28. A method for enhancing the water repellency of an inorganic binder composition, comprising the step of adding a sufficient amount of at least one polyalkylalkylsiloxane comprising at least one hydrocarbon graft having between 6 and 18 carbon atoms, to said composition.

29. The method as claimed in claim 28, wherein the polyalkylalkylsiloxane is incorporated in the form of a powder in the inorganic binder composition.

30. The method as claimed in claim 29, wherein the sufficient amount is between 0.001% and 3% by dry weight of the polyalkylalkylsiloxane, with respect to the total weight of the composition.

31. The method as claimed in claim 30, wherein the amount is between 0.01% and 0.5%, optionally between 0.03% and 0.2%.

32. The method as claimed in claim 28, further comprising the step of mixing the polyalkylalkylsiloxane with a latex composition before its addition to the inorganic binder composition and the amount of the polyalkylalkylsiloxane with respect to the total weight of dry latex, is between 0.1 and 20% by weight, with respect to the weight of the dry latex.

33. The method as claimed in claim 32, wherein the polyalkylalkylsiloxane is added to the latex composition in the form of a redispersible powder.

34. The method as claimed in claim 32, wherein the polyalkylalkylsiloxane is added to the latex composition in the form of an aqueous dispersion during the polymerization or at the end of the polymerization.

35. The method as claimed in claim 32, wherein the polyalkylalkylsiloxane is added in the powder form to the latex composition during the drying by atomization of the latex.

36. The method as claimed in claim 32, in which the latex composition comprises:
at least one water-insoluble polymer,
from 0 to 35% by weight, with respect to the total weight of the polymer, of at least one protective colloid,
from 0 to 30% by weight, with respect to the total weight of the polymer, of anticaking agents, and
from 0.1 to 20% by weight, with respect to the total weight of the polymer, of the polyalkylalkylsiloxane comprising at least one hydrocarbon graft having between 6 and 18 carbon atoms.

37. The method as claimed in claim 36, wherein the water-insoluble polymer is obtained by polymerization of monomers selected from the group consisting of: vinyl esters, alkyl acrylates whose alkyl group presents from 1 to 10 carbon atoms, alkyl methacrylates whose alkyl group presents from 1 to 10 carbon atoms, and vinylaromatic monomers, these monomers optionally being copolymerized with one another or with other monomers possessing ethylenic unsaturation to form homopolymers, copolymers or terpolymers.

38. The method as claimed in claim 37, wherein the monomers are copolymerized with other monomers possessing ethylenic unsaturation selected from the group consisting of ethylene, olefins, vinyl esters of saturated, branched or unbranched, monocarboxylic acids having from 1 to 12 carbon atoms, esters of unsaturated mono- or dicarboxylic acids having 3 to 6 carbon atoms with alkanols having 1 to 10 carbon atoms, vinylaromatic monomers, vinyl halides, diolefins, (meth)allyl esters of (meth)acrylic acid; (meth)allyl esters of the mono- and diesters of maleic, fumaric and itaconic acids; and alkene derivatives of amides of acrylic and methacrylic acids.

39. The method as claimed in claim 36, wherein anticaking agents are present and are aluminum silicates, calcium or magnesium carbonates, aluminum hydrate, bentonite, talc, kaolin, barium sulfate, titanium oxide, or calcium sulfoaluminate (satin white).

40. The method as claimed in claim 28, wherein the polyalkylalkylsiloxane presents diorganosiloxy sequences of formula RR′SiO in which the symbols R and R′, which are identical or different, represent:
alkyl radicals having from 1 to 18 carbon atoms,
cycloalkyl radicals having up to 10 carbon atoms,
alkenyl radicals having from 2 to 4 carbon atoms,
mononuclear aryl radicals having from 6 to 10 carbon atoms, and
with the proviso that at least one of the R or R′ radicals is a hydrocarbon chain having from 6 to 18 carbon atoms.

41. The method as claimed in claim 40, wherein the polymethylalkylorganosiloxane is an α,ω-bis(trimethylsiloxy) methylalkylpolysiloxane polymers of formula (I):
M−[D(R)]ₓ−M (I)
wherein,
x is a whole or fractional number between 5 and 500, optionally between 30 and 60,
M represents (CH₃)₃Si—O—,
D(R) represents —Si(CH₃)(alkyl)-O—,
the R radical being a cyclic, linear or branched radical having from 6 to 18 carbon atoms.

42. The method as claimed in claim 41, wherein the R or R′ have between 8 and 12 carbon atoms, optionally the octyl or dodecyl radical.

43. The method as claimed in claim 28, wherein the graft has a hydrocarbon chain having halogens, hydroxyl groups, ether groups, thioether groups, ester groups, amide groups, carboxyl groups, sulfonic acid groups, carboxylic anhydride groups or carbonyl groups.

44. The method as claimed in claim 28, wherein the inorganic binder is a cement, optionally a cement of Portland of high-alumina or blast-furnace type, or a nonhydraulic binders, optionally a plastes.

45. The method as claimed in claim 28, wherein the inorganic binder is a pozzolanic compound which reacts with lime and selected from the group selected from the group consisting of fly ash, calcined shales, natural pozzolan, and synthetic pozzolan.
